(19) United States
(12) Patent Application Publication
(10) Pub. No.: US 2011/0179654 A1
(43) Pub. Date: Jul. 28, 2011

(54) SHAVING TRAY FOR PENCIL SHARPENER

(75) Inventors: Rong Liu, Vernon Hills, IL (US); Michael L. Parrish, Deer Park, IL (US)

(73) Assignee: ACCO BRANDS USA LLC, Lincolnshire, IL (US)

(21) Appl. No.: 12/692,901

(22) Filed: Jan. 25, 2010

(51) Int. Cl. B43L 23/00

(52) U.S. Cl. 30/454

(57) ABSTRACT

A pencil sharpener includes a base containing a sharpening mechanism, and a shaving tray coupled to the base and movable between an installed position and an uninstalled position relative to the base. The shaving tray defines a chamber configured to receive and hold shavings produced during a sharpening operation. The shaving tray includes a body, an aperture in the body configured to receive shavings for passage into the chamber, a movable member configured to selectively cover the aperture to inhibit shavings from leaving the chamber through the aperture, and a biasing member coupled to the body and to the movable member to bias the movable member into a closed position covering the aperture.

### BACKGROUND

The present invention relates to pencil sharpeners, and more particularly to the collection and disposal of shavings created during use of pencil sharpeners.

Pencil sharpeners, both manual and powered, commonly include a shaving tray or container for collecting shavings created during the sharpening of pencils.

### SUMMARY

One common problem with pencil sharpener shaving trays is that a user often spills shavings from the tray when attempting to empty the tray. Disconnecting the tray from the sharpener and transporting the tray to a waste bin can lead to spilling the shavings from the tray. The present invention provides an improved shaving tray arrangement for a pencil sharpener.

In one embodiment, the invention provides a pencil sharpener including a base containing a sharpening mechanism, and a shaving tray coupled to the base and movable between an installed position and an uninstalled position relative to the base. The shaving tray defines a chamber configured to receive and hold shavings produced during a sharpening operation. The shaving tray includes a body, an aperture in the body configured to receive shavings for passage into the chamber, a movable member configured to selectively cover the aperture to inhibit shavings from leaving the chamber through the aperture, and a biasing member coupled to the body and to the movable member to bias the movable member into a closed position covering the aperture.

In another embodiment the invention provides a pencil sharpener including a base containing a sharpening mechanism, and a shaving tray coupled to the base and movable between an installed position and an uninstalled position relative to the base. The shaving tray defines a chamber configured to receive and hold shavings produced during a sharpening operation. The shaving tray includes a body, an aperture in the body configured to receive shavings for passage into the chamber, a panel slidably coupled with the body and configured to selectively cover the aperture to inhibit shavings from leaving the chamber through the aperture, and a biasing member coupled to the body and to the panel to bias the panel into a closed position covering the aperture. The panel is automatically moved to an open position exposing the aperture when the shaving tray is in the installed position, and the panel is automatically moved by the biasing member to the closed position when the shaving tray is in the uninstalled position.

Other aspects of the invention will become apparent by consideration of the detailed description and accompanying drawings.

### BRIEF DESCRIPTION OF THE DRAWINGS

FIG. 1 is a perspective view of a pencil sharpener embodying the invention.

FIG. 2 is an exploded view of the pencil sharpener of FIG. 1 showing the shaving tray removed.

FIG. 3 is a perspective view of the shaving tray shown in its closed position.

FIG. 4 is a perspective view of the shaving tray shown in its open position.

FIG. 5 is a partial section view of the pencil sharpener of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

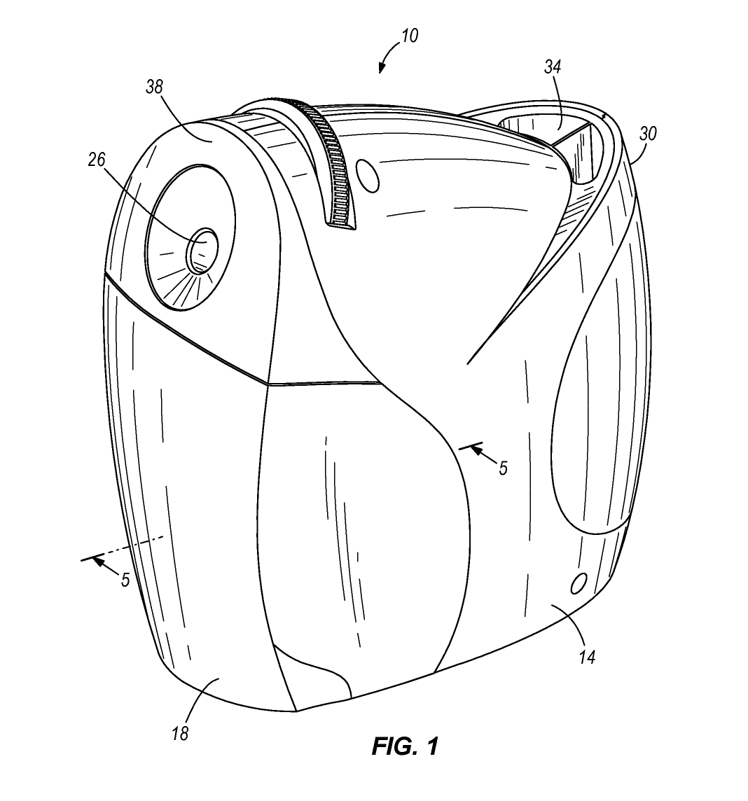

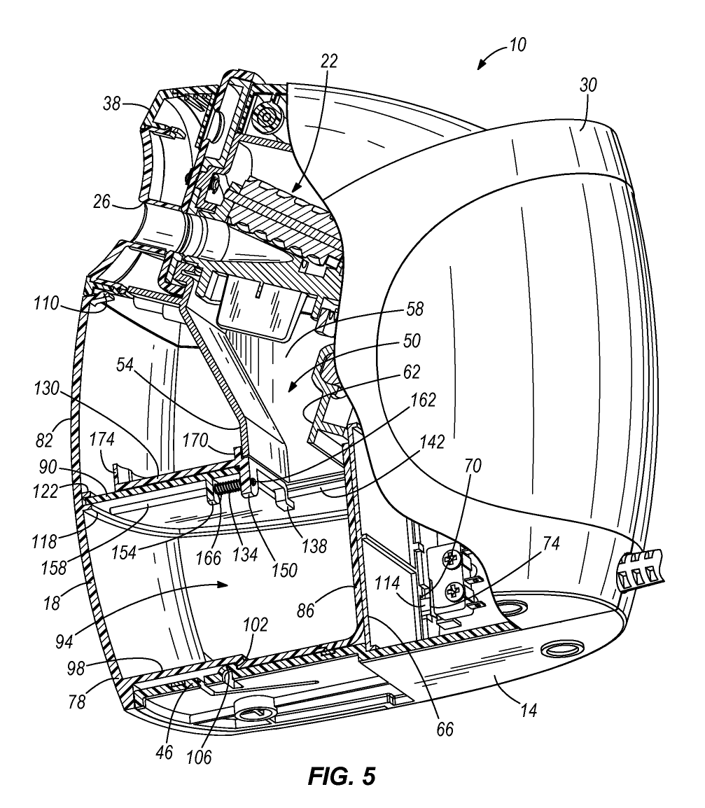

FIGS. 1-5 illustrate a pencil sharpener 10 having a base 14 and a removable shaving container or tray 18. The base 14 contains a sharpening mechanism 22 (see FIG. 5) operable to sharpen pencils upon insertion of the pencil into the sharpening hole 26. The illustrated pencil sharpener 10 is a powered (e.g., electric) pencil sharpener with a powered sharpening mechanism 22, however, the invention can also be practiced with manual pencil sharpeners of the type where the sharpening mechanism is actuated manually.

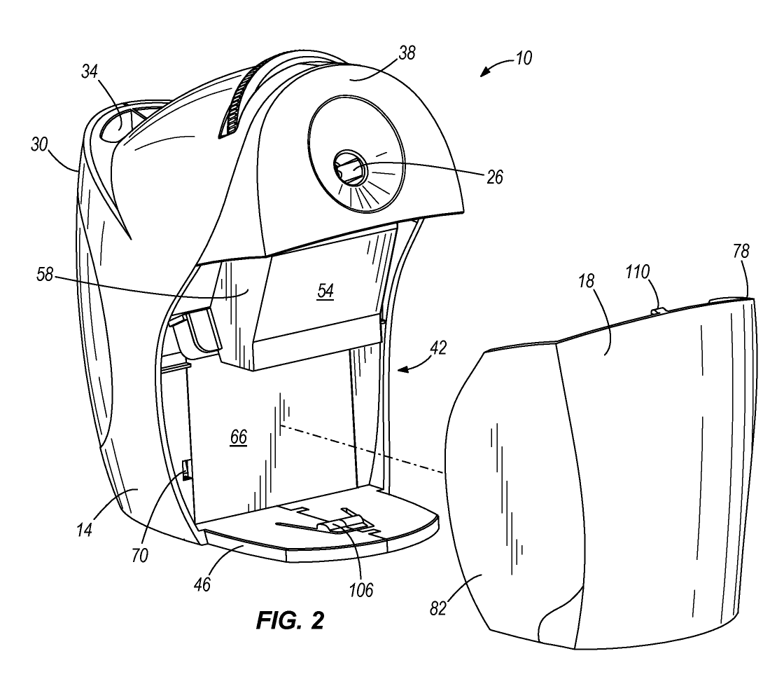

The illustrated base 14 includes a rear end 30 having a pencil holding recess 34, and a forward end 38 in which the sharpening hole 26 is located. As best shown in FIG. 2, the forward end 38 also includes a shaving tray receiving portion 42 sized and configured to receive the shaving tray 18 when the shaving tray 18 is coupled to the base 14 in the installed position (see FIGS. 1 and 5). As shown in FIG. 2, the shaving tray receiving portion 42 is defined in part by a bottom wall 46 of the base 14 and by a portion of the base 14 defining a shavings passageway 50 (see FIG. 5) leading from the sharpening mechanism 22 to the installed shaving tray 18. A front wall portion 54, two side wall portions 58 (only one is shown), and a rear wall portion 62 (see FIG. 5) cooperate to define the shavings passageway 50. The tray receiving portion 42 also includes a lower wall portion 66 having an aperture 70 therein to provide communication between the shaving tray 18 and a switch 74 (e.g., a limit switch, micro switch, etc.) in the base 14 that determines whether the shaving tray 18 is in the installed position to allow operation of the sharpening mechanism 22. This feature will be described in more detail below.

The shaving tray 18 is sized and configured to be received in the shaving tray receiving portion 42 of the base 14 (i.e., the installed position). In the illustrated embodiment, the outer geometry of the shaving tray 18 corresponds to the outer geometry of the base 14 such that when in the installed position as shown in FIG. 1, the base 14 and the shaving tray 18 together form a smooth, continuous, and aesthetically pleasing outer surface of the pencil sharpener 10. The shaving tray 18 includes a body 78 formed by a plurality of wall portions, which in the illustrated embodiment are made of plastic. Likewise, in the illustrated embodiment, the wall portions of the base 14 are also made of plastic.

The shaving tray 18 includes and outer wall portion 82, an inner wall portion 86, and an upper wall portion 90 that together define a chamber 94 (see FIG. 5) configured to receive and hold shavings produced during a sharpening operation of the pencil sharpener 10. The outer wall portion 82 includes a bottom portion 98 configured to rest on the bottom wall 46 of the base 14 when the shaving tray 18 is in the installed position. As shown in FIG. 5, a shoulder 102 in the bottom portion 98 cooperates with a resilient locking feature 106 on the bottom wall 46 to help releasably secure the shaving tray 18 in the installed position. Additionally, the outer wall portion 82 includes a locking feature 110 near the upper end of the shaving tray 18 that releasably engages with the base 14 (see FIG. 5) when the shaving tray 18 is in the installed position to help releasably secure the shaving tray 18 to the base 14. The illustrated releasable locking features 106 and 110 of the pencil sharpener 10 are configured such that a user can pull the shaving tray 18 away from the base 14 manually to remove the shaving tray 14 (i.e., to move the shaving tray 18 to the uninstalled position shown in FIG. 2). Of course, other releasable locking features and arrangements can be substituted for those shown in the illustrated embodiment.

The inner wall portion 86 includes a projection 114 positioned to be received through the aperture 70 to engage the switch 74 when the shaving tray 18 is in the installed position (see FIG. 5). The projection 114 engages the switch 74, thereby completing a circuit to enable energization of the powered sharpening mechanism 22. If the shaving tray 18 is not installed, the circuit is broken and the pencil sharpener 10 will not operate. This ensures that the shaving tray 18 must be present and fully installed before sharpening is permitted, so that shavings cannot be generated when the shaving tray 18 is uninstalled.

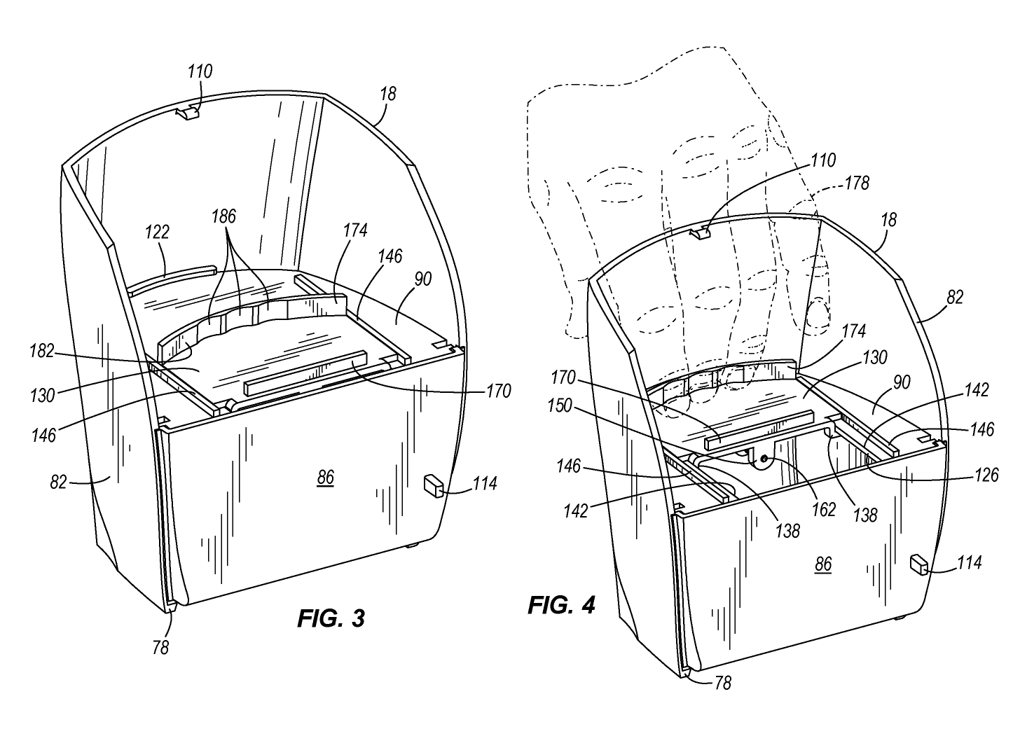

Referring now to FIGS. 3-5, the upper wall portion 90 of the body 78 is coupled with the outer wall portion 82 and the inner wall portion 86 to form a generally horizontal surface of the shaving tray 18 that defines the upper end of the chamber 94. As best shown in FIG. 5, the upper wall portion 90 is supported by a support rib 118 on the outer wall portion 82 and engages the inner wall portion 86. A securing rib 122 on the outer wall portion 82 holds the upper wall portion 90 in place by preventing it from lifting off of the support rib 118. As best shown in FIG. 4, the upper wall portion 90 defines an aperture 126 in the body 78 configured to receive shavings for passage into the chamber 94. The illustrated aperture 126 is generally rectangular in shape, bounded on three sides by edges of the upper wall portion 90 and on the fourth side by the inner wall portion 86. In other embodiments, the aperture 126 can take different shapes and could be entirely bounded by the upper wall portion 90. In the illustrated embodiment, the aperture 126 provides the only access into and out of the chamber 94 defined by the body 78. However, in other embodiments, a secondary, closable access port to the chamber could be provided.

The shaving tray 18 further includes a movable member, which in the illustrated embodiment, takes the form of a panel 130 configured to selectively cover the aperture 126 to inhibit shavings from leaving the chamber 94 through the aperture 126. The panel 130 is biased by a biasing member, in the form of a spring 134 (see FIG. 5), into a closed position covering the aperture 126, as shown in FIG. 3. The bias of the biasing member 134 can be overcome to move the panel 130 to an open position, in which the aperture 126 is exposed to permit passage of shavings into or out of the chamber 94. As will be described further below, the panel 130 is automatically moved to the open position, exposing the aperture 126, when the shaving tray 18 is in the installed position (see FIG. 5), and the panel 130 is automatically moved by the biasing member 134 to the closed position when the shaving tray 18 is removed from the base 14 and is thus in the uninstalled position (see FIG. 3).

In the illustrated embodiment, the panel 130 is slidably mounted to the body 78, and more specifically to the upper wall portion 90, for sliding movement between the open and closed positions. The panel 130 and the upper wall portion 90 together define a cooperating tongue and groove arrangement that facilitates the sliding movement of the panel 130 relative to the body 78. In the illustrated embodiment, and as best shown in FIGS. 4 and 5, the panel 130 includes formations 138 at the corners closest to the inner wall portion 86 that together with the remainder of the panel 130 define grooves for receiving opposing edges 142 of the upper wall portion 90 defining the aperture 126 (i.e., tongues). The edges 142 are received above the formations 138 and below the remainder of the panel 130 to define the tongue and groove arrangement that facilitates sliding of the panel 130 relative to the body 78 between the open and closed positions. Those skilled in the art will understand that the tongue and groove arrangement could also be reversed such that the tongue portion is formed on the panel 130 and the groove portion is formed on the upper wall portion 90. Alternatively, other arrangements to facilitate the sliding engagement between the panel 130 and the body 78 can be substituted. The illustrated upper wall portion 90 further includes guide rails 146 configured to guide the sliding movement of the panel 130 relative to the body 78.

The biasing member 134 is coupled between the body 78 and the panel 130 as best shown in FIG. 5. Specifically, the panel 130 includes a projection 150 on its underside and extending into the chamber 94. Likewise, a projection 154 on the underside of the upper wall portion 90 extends into the chamber 94 and is generally aligned with the projection 150 of the panel 130. The spring 134, which in the illustrated embodiment is a compression spring, is positioned or supported on a rod 158 that is received and supported in an aperture 162 in the projection 150 and an aperture 166 in the projection 154. A first end of the spring 134 abuts the projection 150 and a second end of the spring 134 abuts the projection 154. Movement of the panel 130 to the open position, as shown in FIGS. 4 and 5, moves the projections 150 and 154 together, thereby compressing the spring 134 therebetween. The stored energy in the spring 134 biases the projection 150 away from the projection 154, thereby biasing the panel 130 toward the closed position.

The placement and positioning of the biasing member 134 completely on the shaving tray 18 and in the chamber 94 provides a robust, compact, and aesthetically-pleasing design in that the biasing arrangement is generally hidden from view and cannot get caught on portions of the base 14 during installation or removal. There are also not misalignment concerns that may be present if the biasing member 134 were housed on the base 14. Additionally, a user cannot easily access or touch the spring 134. Furthermore, by positioning the biasing member 134 at the top of the chamber 94, just below the upper wall portion 90, the likelihood of shavings collecting up to the level of the spring 134 so as to foul or otherwise impede the spring 134 are low. If desired, a shield member could be added to further protect the spring 134 from shavings within the chamber 94.

When the shaving tray 18 is installed on the base 14, insertion of the shaving tray 18 into the shaving tray receiving portion 42 of the base 14 results in engagement between a lower portion of the front wall portion 54 of the base 14 with a portion of the panel 130 (e.g., a rib or projection 170 on the panel 130—see FIG. 5). As the shaving tray 18 is pushed into the shaving tray receiving portion 42, the engagement between then rib 170 and the front wall portion 54 slides the panel 130 from the closed position to the open position, against the bias of the biasing member 134. The locking features 106 and 110 prevent the bias of the biasing member 134 from disengaging the shaving tray 18 from the base 14. When the shaving tray 18 is in the installed position, the panel 130 is held in the open position such that shavings falling through the shavings passageway 50 can enter and collect in the chamber 94 through the aperture 126.

When a user removes the shaving tray 18 from the base 14 to empty the shavings collected in the chamber 94 into a waste bin or receptacle, the force of the locking features 106 and 110 is overcome by the user as the shaving tray 18 is pulled from the shaving tray receiving portion 42. The biasing member 134 is then free to move the panel 130 toward the closed position as the shaving tray 18 moves away from the front wall portion 54 and reaches the fully closed position immediately when the engagement between the rib 170 and the front wall portion 54 is eliminated. Therefore, spillage of shavings during removal of the shaving tray 18 from the base 14 is prevented. With the shaving tray removed, and the panel 130 automatically biased to the closed position, the user can then safely transport the shaving tray 18 to a waste receptacle for disposal of the shavings without the fear of shavings being accidentally spilled during transport of the shaving tray 18.

To remove the shavings from the chamber 94, the user simply slides the panel 130 to the open position and holds it there in the manner shown in FIG. 4. With the aperture 126 exposed, the user can empty the shavings into the waste receptacle in a pouring and/or shaking motion. To facilitate manual movement of the panel 130 to the open position, the panel 130 includes a projection 174 that can be pushed with the user's fingers 178 to slide the panel 130 against the bias of the biasing member 134. As best seen in FIG. 3, the projection 174 includes a surface 182 having contoured recesses 186 configured to receive the fingertips of the user. In addition to added comfort to the user, the contoured recesses 186 provide intuitive information to the user on how to slide the panel 130 (e.g., by placing ones fingertips in the recesses 186 to pull the panel 130 to the open position). Of course, the user can slide the panel 130 in alternative manners, including by pulling on the rib 170. Other features to facilitate manually opening the panel 130 can also be substituted.

While the illustrated sliding panel 130 and biasing member 134 arrangement is deemed to provide a very robust, unobtrusive, compact, and efficient design, alternatives to the illustrated sliding panel 130 and the illustrated biasing arrangement can be substituted without deviating from the present invention. For example, the movable member could take the form of a pivoting panel hinged on the upper wall portion 90 or the inner wall portion 86 and biased closed by a torsion spring. Likewise, other biasing arrangements, such as a tension spring coupled between the panel 130 and the inner wall portion 86, could be used.

Various features and advantages of the invention are set forth in the following claims.

What is claimed is:

1. A pencil sharpener comprising:
a base containing a sharpening mechanism; and
a shaving tray coupled to the base and movable between an installed position and an uninstalled position relative to the base, the shaving tray defining a chamber configured to receive and hold shavings produced during a sharpening operation, the shaving tray including
a body,
an aperture in the body configured to receive shavings for passage into the chamber,
a movable member configured to selectively cover the aperture to inhibit shavings from leaving the chamber through the aperture, and
a biasing member coupled to the body and to the movable member to bias the movable member into a closed position covering the aperture.

2. The pencil sharpener of claim 1, wherein the movable member is automatically moved to an open position exposing the aperture when the shaving tray is in the installed position, and wherein the movable member is automatically moved by the biasing member to the closed position when the shaving tray is in the uninstalled position.

3. The pencil sharpener of claim 2, wherein the movable member is automatically moved to the open position when the shaving tray is in the installed position by engagement of a portion of the base with a portion of the movable member.

4. The pencil sharpener of claim 1, wherein the movable member is a panel slidably coupled with the body.

5. The pencil sharpener of claim 4, wherein the panel includes a projection, the biasing member engaging the projection to bias the panel.

6. The pencil sharpener of claim 5, wherein the biasing member is a spring positioned on a rod, the rod received in an aperture in the projection such that a first end of the spring abuts the projection on the panel.

7. The pencil sharpener of claim 6, wherein the body of the shaving tray includes a projection having an aperture receiving the rod such that a second end of the spring abuts the projection on the body.

8. The pencil sharpener of claim 4, wherein the panel and the body together define a cooperating tongue and groove arrangement to facilitate the panel sliding relative to the body.

9. The pencil sharpener of claim 4, wherein the body includes guide rails configured to guide sliding movement of the panel relative to the body.

10. The pencil sharpener of claim 1, wherein the movable member includes a projection configured to be manually engaged by a user to move the movable member to an open position exposing the aperture for emptying the shavings from the chamber.

11. The pencil sharpener of claim 10, wherein the projection includes a surface having contoured recesses configured to receive fingertips of a user.

12. The pencil sharpener of claim 1, wherein the biasing member is positioned within the chamber of the shaving tray.

13. A pencil sharpener comprising:
a base containing a sharpening mechanism; and
a shaving tray coupled to the base and movable between an installed position and an uninstalled position relative to the base, the shaving tray defining a chamber configured to receive and hold shavings produced during a sharpening operation, the shaving tray including
a body,
an aperture in the body configured to receive shavings for passage into the chamber,
a panel slidably coupled with the body and configured to selectively cover the aperture to inhibit shavings from leaving the chamber through the aperture, and
a biasing member coupled to the body and to the panel to bias the panel into a closed position covering the aperture;
wherein the panel is automatically moved to an open position exposing the aperture when the shaving tray is in the installed position, and wherein the panel is automatically moved by the biasing member to the closed position when the shaving tray is in the uninstalled position.

14. The pencil sharpener of claim 13, wherein the movable member is automatically moved to the open position when the shaving tray is in the installed position by engagement of a portion of the base with a portion of the panel.

15. The pencil sharpener of claim 13, wherein the panel includes a projection, the biasing member engaging the projection to bias the panel.

16. The pencil sharpener of claim 15, wherein the biasing member is a spring positioned on a rod, the rod received in an aperture in the projection such that a first end of the spring abuts the projection on the panel.

17. The pencil sharpener of claim 16, wherein the body of the shaving tray includes a projection having an aperture receiving the rod such that a second end of the spring abuts the projection on the body.

18. The pencil sharpener of claim 13, wherein the panel and the body together define a cooperating tongue and groove arrangement to facilitate the panel sliding relative to the body.

19. The pencil sharpener of claim 13, wherein the body includes guide rails configured to guide sliding movement of the panel relative to the body.

20. The pencil sharpener of claim 13, wherein the movable member includes a projection configured to be manually engaged by a user to move the movable member to the open position exposing the aperture for emptying the shavings from the chamber.

21. The pencil sharpener of claim 20, wherein the projection includes a surface having contoured recesses configured to receive fingertips of a user.

22. The pencil sharpener of claim 13, wherein the biasing member is positioned within the chamber of the shaving tray.
